(19) United States
(12) Patent Application Publication
(10) Pub. No.: US 2024/0269683 A1
(43) Pub. Date: Aug. 15, 2024

(54) A HYDRAULIC SYSTEM FOR A ROLLER CRUSHER

(71) Applicant: Metso USA Inc., Brookfield, WI (US)

(72) Inventor: Paulo Barscevicius, Sorocaba, SP (BR)

(73) Assignee: Metso USA Inc., Brookfield, WI (US)

(21) Appl. No.: 18/568,088

(22) PCT Filed: Jun. 22, 2022
(86) PCT No.: PCT/US2022/034446

§ 371 Date: Dec. 7, 2023

(30) Foreign Application Priority Data
Jun. 23, 2021 (SE) 2150814-8

(51) Int. Cl. B02C 4/32; B02C 4/02

(52) U.S. Cl. CPC B02C 4/32; B02C 4/02

(57) ABSTRACT

A hydraulic system for a roller crusher including a first main cylinder connectable to a first movable bearing of the roller crusher, a second main cylinder connectable to a second movable bearing of the roller crusher, a first crossing cylinder to the first movable bearing of the roller crusher, a second crossing cylinder connectable to the second movable bearing of the roller crusher. A first compression chamber of the first crossing cylinder is fluidly connected to a second rebound chamber of the second crossing cylinder, and the first rebound chamber of the first crossing cylinder is fluidly connected to the second compression chamber of the second crossing cylinder.

### BACKGROUND

Roller crushers are used for the comminution of material, e.g. ores. The comminution of material happens in-between two rollers, which together defines a crushing gap, where material to be crushed is introduced. The rollers are installed in a machine frame via bearing housings. Each roller may be provided with one, two or more independent bearing housings. During comminution of material large forces are constantly applied on the material and in return the rollers crushing the material. To assure the roller crusher is not damaged by these forces, one of the rollers is installed in fixed bearing housings, i.e. bearing housings which are fixed in relation to the machine frame, and the other roller is installed in movable bearing housings, i.e. bearing housings which may move in relation to the machine frame. Consequently, the roller crusher comprises a movable roller and a fixed roller. Thus, when a large load is applied on the rollers, the movable roller may move away from the fixed roller, which in return widens the crushing gap and lessens the load. However, to assure the movable roller returns to its optimal crushing position, and delivers a sufficient crushing pressure during operation, the floating roller is biased towards the fixed roller via a hydraulic system. The hydraulic system biases the movable roller by delivering a force to the movable bearing housings of the movable roller. However, since the movable bearing housings are independent from each other the movement of the moveable roller may lead to skewing, i.e. the two rollers become unparallel. Skewing may for example happen if a feed of material is unevenly distributed when entering the crushing gap or if material having varying properties, such as moisture content, enters the crusher or if a tamp event occurs.

Skewing of the floating roller may compromise seals, and in some cases where flanges are installed on one of the rollers, skewing may lead to unwanted contact between the roller and the flanges. Thus, making it hard to use flanged rollers if skewing is an issue.

### SUMMARY

It is an object of the present invention to provide a solution for preventing or at least reducing skewing in rollers crusher which is furthermore flexible and easily adaptable to a wide variety of roller crushers.

According to a first aspect, this and other objects are achieved by a hydraulic system for a roller crusher comprising a machine frame, a fixed roll supported by one or more fixed bearing housings, a movable roll supported by a first movable bearing housing and a second movable bearing housing, wherein the one or more fixed bearing housings are fixed relative to the machine frame, wherein the first movable bearing housing and the second movable bearing housing are movable relative to the machine frame, and wherein the fixed roll and the movable roll defines a crushing gap for receiving material to be comminuted, the hydraulic system comprising:
a first main cylinder connectable to the first movable bearing housing and comprising a first main piston for exerting a force along a first axis resulting in a force on the first movable bearing housing, and a first main hydraulic chamber for controlling the force exerted by the first main piston,
a second main cylinder connectable to the second movable bearing housing and comprising a second main piston for exerting a force along a second axis parallel to the first axis resulting in a force on the second movable bearing housing, and a second main hydraulic chamber for controlling the force exerted by the second main piston,
a first crossing cylinder connectable to the first movable bearing housing and comprising a first synchronizing hydraulic chamber and a first synchronizing piston for exerting a force along the first axis resulting in a force on the first movable bearing housing, wherein the first synchronizing piston is operationally coupled to the first main piston, wherein the first synchronizing piston extends into the first synchronizing hydraulic chamber and comprises a first synchronizing piston element separating the first synchronizing hydraulic chamber into a first compression chamber and a first rebound chamber,
a second crossing cylinder connectable to the second movable bearing housing and comprising a second synchronizing hydraulic chamber and a second synchronizing piston for exerting a force along the second axis resulting in a force on the second movable bearing housing, wherein the second synchronizing piston is operationally coupled to the second main piston, wherein the second synchronizing piston extends into the second synchronizing hydraulic chamber and comprises a second synchronizing piston element separating the second synchronizing hydraulic chamber into a second compression chamber and a second rebound chamber, and
wherein the first compression chamber is fluidly connected to the second rebound chamber and the first rebound chamber is fluidly connected to second compression chamber. Thereby, the first crossing cylinder and the second crossing cylinder are allowed to synchronize movement of the first synchronizing piston and the second synchronizing piston.

Consequently, a hydraulic system is provided where movement of the first main piston and the second main piston are synchronized via the operational coupling to the first crossing cylinder and the second crossing cylinder, respectively. The movement of the synchronizing pistons is synchronized by the first rebound chamber being fluidly connected to the second compression chamber, and the second rebound chamber being fluidly connected to the first compression chamber, thus when the volume of the first rebound chamber is compressed, e.g. when the first synchronizing piston moves along the first axis, fluid is transferred to the second compression chamber which expands the volume of the second compression chamber, and thus moving the second synchronizing in sync with the first synchronizing piston. Furthermore, since the main pistons are operationally coupled to the synchronizing pistons the movement of these are also synchronized. Synchronizing the movement between the pistons assures that when the hydraulic system is connected to a roller crusher, movement of the movable bearing housings is synchronized, thus avoiding skewing of the roller. Furthermore, only the main cylinders need to contribute to the crushing force exerted along the first axis and the second axis, while the synchronizing cylinders need only to synchronize movement of the different pistons, this further simplifies hydraulic wiring needed for the hydraulic system.

The first synchronizing hydraulic chamber and the second synchronizing hydraulic chamber are preferably formed with the same dimensions, thus leading to the volume of the first compression chamber and the first rebound chamber matching that of the second compression chamber and the second rebound chamber, respectively.

In the context of this disclosure when components are described as operationally coupled it is to be understood as when the components are operated they are coupled together.

In the context of this disclosure when components are described as connected it is not to only be interpreted as a direct connection between the components, the connection may also be an indirect connection achieved via intermediate components.

In an embodiment the first main hydraulic chamber is hollow and defines a first inner compartment, wherein the second main hydraulic chamber is hollow and defines a second inner compartment, and wherein the first crossing cylinder is arranged in the first inner compartment and the second crossing cylinder is arranged in the second inner compartment.

Consequently, a very space efficient set-up between the main cylinders and the synchronizing cylinders is achieved. Furthermore, arranging the synchronizing cylinders at least partly within the main cylinders may further facilitate an operational coupling between the synchronizing cylinders and the main cylinders.

In an embodiment the first main hydraulic chamber occupies 60-90% of a first cylinder area and the second main hydraulic chamber occupies 60-90% of a second cylinder area, wherein the first cylinder area is a cross-sectional area of the first hydraulic chamber and the first inner compartment in a plane perpendicular to the first axis and the second cylinder area is a cross-sectional area of the second hydraulic chamber and the second inner compartment in a plane perpendicular to the second axis.

The applicant has found that by having the main hydraulic chambers occupying 60-90% of the cylinder areas, the hydraulic chambers do not need an increase in diameter in comparison to the conventional hydraulic systems currently installed on roller crushers in order to deliver a sufficient force to the roller crusher. Thus, facilitating the retrofitting of the hydraulic system, and minimizing the changes needed in a manufacturing facility for manufacturing hydraulic systems and roller crushers with a hydraulic system according to the invention.

In an embodiment the fluid connection between the first compression chamber and the second rebound chamber forms a first closed fluid circuit and the fluid connection between the first rebound chamber and the second compression chamber forms a second closed fluid circuit.

Consequently, the synchronization of movement of the piston may be achieved autonomous without the need for external control, as the operation of the crossing cylinders will always be synchronized. This also further simplifies the hydraulic wiring needed in the system. In some cases, relieve valves may be connected to the first closed fluid circuit and the second closed fluid circuit to have a failsafe.

In an embodiment the hydraulic system comprises one or more hydraulic accumulators in fluid connection with the first main hydraulic chamber and/or the second main hydraulic chamber.

Hydraulic accumulators may help in providing additional force to the main cylinder and/or stabilizing the force delivered by the main cylinders.

In an embodiment the first synchronizing piston and the first synchronizing piston element are integrally connected, and the second synchronizing piston and the second synchronizing piston element are integrally connected.

Consequently, it is assured that the piston elements do not move relative to the synchronizing pistons, thus assuring the movement of the synchronizing pistons are synchronized when fluid is moved between the rebound chambers and the compression chambers. Alternatively, the piston elements may be provided as seals on the synchronizing pistons. Providing the piston elements as seals may case manufacturing of the synchronizing pistons, as seals may be added on a wide variety of pistons. Furthermore, seals are cheap and easily replaceable in case of wear and tear.

In an embodiment the first crossing cylinder is engaged with the first main cylinder to prevent movement of the first crossing cylinder relative to the first main cylinder in a first plane perpendicular to the first axis, and/or the second crossing cylinder is engaged with the second main cylinder to prevent movement of the second crossing cylinder relative to the second main cylinder in a second plane perpendicular to the second axis.

During operation of a roller crusher large forces are present which may lead to vibrations or lateral forces, such forces may move the cylinders relative to each other, thus potentially impacting the synchronization of the movement between the main pistons. Consequently, by preventing movement of the crossing cylinders relative to the main cylinders, these negative effects may be eliminated or at least reduced.

In an embodiment the first main piston is connected with the first synchronizing piston and/or the second main piston is connected with the second synchronizing piston.

Consequently, allowing the main cylinders to be operationally coupled with the crossing cylinders. By connecting the main pistons together with the synchronizing pistons, it is assured that movement of the main pistons is always synchronized by the crossing cylinders. The connection between the main pistons and the synchronizing piston may be achieved by bolting or a locking engagement, e.g. a male-female connection.

In an embodiment the first main piston is integrally connected with the first synchronizing piston and/or the second main piston is integrally connected with the second synchronizing piston.

An integral connection may assure the main cylinders and the synchronizing cylinder are operationally coupled. An integral connection may be achieved by forming the main pistons together with the synchronizing pistons, or by welding and the main pistons together with the synchronizing pistons.

In an embodiment the first main piston is configured to deliver the force along the first axis onto the first synchronizing piston and/or the second main piston is configured to deliver the force along the second axis onto the second synchronizing piston.

Thus, allowing the main cylinders and the synchronizing cylinder to be operationally coupled without forming a connection locking between the main pistons and the synchronizing pistons. Not locking the main pistons together with the synchronizing pistons may case the assembling and disassembling of the hydraulic system, which may prove especially advantageous when mounting the hydraulic system on a roller crusher.

According to a second aspect of the invention a roller crusher for comminution of material is provided, the roller crusher comprising:
a machine frame,
a fixed roll supported by fixed bearing housings, wherein the fixed bearing housings are fixed relative to the machine frame,
a movable roll supported by movable bearing housings, wherein the movable bearing housings are movable relative to the machine frame, wherein the fixed roll and the movable roll defines a crushing gap for receiving material to be comminuted, and
a hydraulic system according to the first aspect of the invention, wherein the hydraulic system is configured to deliver a force onto the movable bearing housing to bias the movable roll towards the fixed roll.

The different aspects of the present invention can be implemented in different ways described above and in the following, each yielding one or more of the benefits and advantages described in connection with at least one of the aspects described above, and each having one or more preferred embodiments corresponding to the preferred embodiments described in connection with at least one of the aspects described above and/or disclosed in the dependent claims.

Furthermore, it will be appreciated that embodiments described in connection with one of the aspects described herein may equally be applied to the other aspects.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIG. 1 depicts a schematic cross-sectional view of an embodiment of a roller crusher according to a second aspect of the invention.

FIG. 2 depicts a schematic cross-sectional view of an embodiment of a hydraulic system according to a first aspect of the invention connected to movable bearing housings of a roller crusher.

FIG. 3a depicts a schematic cross-sectional view of a first main cylinder according to an embodiment of the invention.

FIG. 3b depicts a schematic top view of the first main cylinder of FIG. 3a.

FIG. 4a depicts a schematic cross-sectional view of a first crossing cylinder according to an embodiment of the invention.

FIG. 4b depicts a schematic top view of the first crossing cylinder of FIG. 4a.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and to convey the scope of the invention to the skilled person.

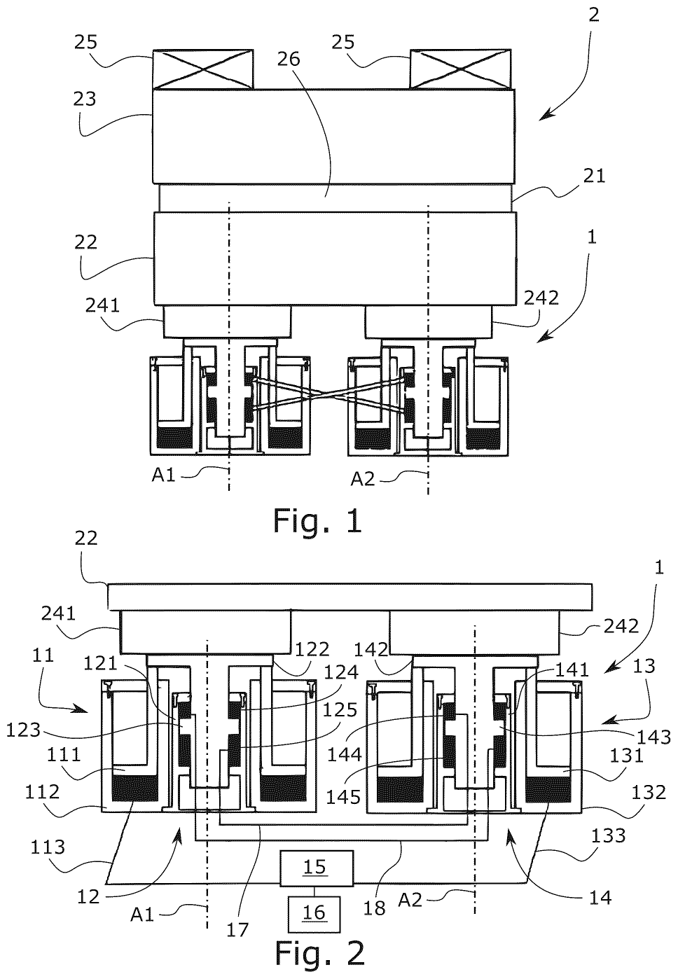

Referring initially to FIG. 1, which depicts a schematic cross-sectional view of an embodiment of a roller crusher 2 according to a second aspect of the invention. The roller crusher 2 being for comminution of material, such as ore. The roller crusher 2 comprises a machine frame 21 supporting two rollers 22 and 23 of the roller crusher. The two rollers 22 and 23 are a fixed roll 23 and a movable roll 22. The fixed roll 23 is supported by fixed bearing housings 25. The fixed bearing housings 25 are placed on the machine frame 21. The fixed bearing housings 25 are fixed relative to the machine frame 21. The movable roll 22 is supported by two movable bearing housings 241 and 242. A first movable bearing housing 241 and a second movable bearing housing 242. The two movable bearing housings 241 and 242 are movable relative to the machine frame 21. The first movable bearing housing 241 is movable along a first axis A1 and the second movable bearing housing 242 is movable along a second axis A2. In the shown embodiment the first axis A1 is parallel to the second axis A2. The fixed roll 23 and the movable roll 22 defines a crushing gap 26 for receiving material to be comminuted. In connection with the two movable bearing housings 241 and 242 is a hydraulic system 1. The hydraulic system 1 is configured to deliver a force onto the movable bearing housings 241 and 242 to bias the movable roll 22 towards the fixed roll 23. During operation the movable roll 22 may move along the first axis A1 and the second axis A2 in order to increase or decrease the crushing gap 26 between the fixed roll 23 and the movable roll 22. The hydraulic system 1 will be explained in greater detail in the following figures.

Referring to FIG. 2, which depicts a schematic cross-sectional view of an embodiment of a hydraulic system 1 according to a first aspect of the invention connected to movable bearing housings 241 and 242 of a roller crusher 2. The hydraulic system 1 comprises a first main cylinder 11 and a second main cylinder 13. The first main cylinder 11 and the second main cylinder 13 are indirectly connected to the first movable bearing housing 241 and the second movable bearing housing 242, respectively. The indirect connection for the first main cylinder 11 is achieved via a first synchronizing piston 122 and for the second main cylinder 13 via a second synchronizing piston 142. The first synchronizing piston 122 and the second synchronizing piston 142 abut the first movable bearing housing 241 and the second movable bearing housing, respectively. Alternatively, the first main cylinder 11 and the second main cylinder 13 may be directly connected to the first movable bearing housing 241 and the second movable bearing housing 242, respectively. The connection between the first movable bearing housing 241 and the first main cylinder 11, assures that when the first main cylinder 11 generates a force along the first axis A1 towards the first movable roller 241 it results in a force on the first movable bearing housing 241. The connection between the second movable bearing housing 242 and second main cylinder 13, assures that when the second main cylinder 13 generates a force along the second axis A2 towards second movable roller 242 it results in a force on the second movable bearing housing 242. The first main cylinder 11 and the second main cylinder 13 comprises a first main piston 111 and a second main piston 131, respectively. The first main piston 111 and the second main piston are movable along the first axis A1 and the second axis A2, respectively. The first main piston 111 being for exerting a force along the first axis A1 resulting in a force on the first movable bearing housing 241. The second main piston 131 being for exerting a force along the second axis A2 resulting in a force on the second movable bearing housing 242. The first main cylinder 11 and the second main cylinder 13 further comprises a first main hydraulic chamber 112 for controlling the force exerted by the first main piston 111 and a second main hydraulic chamber 132 for controlling the force exerted by the second main piston 131. The first main hydraulic chamber 112 and the second hydraulic chamber are configured to accommodate a pressurized fluid. Pressurized fluid in the first hydraulic chamber 112 is configured to deliver a fluid force onto the first main piston 111, which results in the first main piston 111 delivering a force onto the first movable bearing housing 241. Pressurized fluid in the second hydraulic chamber 132 is configured to deliver a fluid force onto the second main piston 131, which results in the second main piston 131 delivering a force onto the second movable bearing housing 242. The fluid and the fluid pressure within the first main hydraulic chamber 112 and the second main hydraulic chamber 132 are in the shown embodiment controllable via a first hydraulic line 113 and second hydraulic line 133, respectively. The first hydraulic line 113 fluidly connects the first main hydraulic chamber 112 to a controller 15, and the second hydraulic line 133 fluidly connects the second main hydraulic chamber 132 to the controller 15. The controller 15 may control the fluid and the fluid pressure within the first main hydraulic chamber 112 and the second main hydraulic chamber 132. The controller 15 may control the fluid and the fluid pressure via hydraulic means 16, such as one or more pumps and/or one or more accumulators in fluid connection with the first hydraulic line 113 and the second hydraulic line 133. In other embodiments the first main hydraulic chamber 112 and/or the second main hydraulic chamber 132 is pressurized and fluidly sealed off, thus allowing the first main cylinder 11 and/or the second main cylinder 13 to provide a constant force onto the first movable bearing housing 241 and/or the second movable bearing housing 242, respectively.

The hydraulic system 1 further comprises a first crossing cylinder 12 and a second crossing cylinder 14 connected to the first movable bearing housing 241 and the second movable bearing housing 242, respectively. In the shown embodiment, the first crossing cylinder 12 and the second crossing cylinder 14 are directly connected to the first movable bearing housing 241 and the second movable bearing housing 242, respectively. Alternatively, the first crossing cylinder 12 and/or the second crossing cylinder may be indirectly connected to the first movable bearing housing 241 and/or the second movable bearing housing 242, respectively. The indirect connection may be achieved via shims or the main pistons 111 and 131. The first crossing cylinder 12 comprises a first synchronizing hydraulic chamber 121 and a first synchronizing piston 122. The second crossing cylinder 14 comprises a second synchronizing hydraulic chamber 141 and a second synchronizing piston 142. The first synchronizing piston 122 and the second synchronizing piston 142 are movable along the first axis A1 and the second axis A2, respectively. The first synchronizing piston 122 abuts the first movable bearing housing 241, thus forming a connection between the first crossing cylinder 12 and the first movable bearing housing 241. The first synchronizing piston 122 being for exerting a force along the first axis A1 resulting in a force on the first movable bearing housing 241. The second synchronizing piston 142 abuts the second movable bearing housing 242, thus forming a connection between the second crossing cylinder 14 and the second movable bearing housing 242. The second synchronizing piston 142 being for exerting a force along the second axis A2 resulting in a force on the second movable bearing housing 242. The first synchronizing piston 122 and the second synchronizing piston 142 are operationally coupled to the first main piston 111 and the second main piston 131, respectively. In the shown embodiment the operational coupling is achieved by the main pistons 111 and 131 being configured to deliver a force along the first axis A1 and second axis A2 onto the synchronizing pistons 122 and 142. In the shown embodiment this is achieved by the first main pistons 111 and the second main piston 131 directly abutting the first synchronizing piston 122 and the second synchronizing piston 142, respectively. Alternatively, shims or similar may be placed in-between the main pistons 111 and 131 and the synchronizing pistons 122 and 142. The operational coupling may alternatively be achieved by connecting the main pistons 111 and 131 to the synchronizing pistons 122 and 142 via bolting or welding. The operational coupling facilitates that the movement of the main pistons 111 and 131 is synchronized with the movement of the movement of the synchronizing pistons 122 and 142, e.g. when high loads generated by material in the crushing gap 26 the operation coupling assures the main pistons 111 and 131 moves in sync with the synchronizing pistons 122 and 142. The first synchronizing piston 122 and the second synchronizing piston 142 extends into the first synchronizing hydraulic chamber 121 and the second synchronizing hydraulic chamber 121, respectively. The first synchronizing piston 122 and the second synchronizing piston 142 comprises a first synchronizing piston element 123 and the second synchronizing piston element 143, respectively. The first synchronizing piston element 123 separates the first synchronizing hydraulic chamber 121 into a first compression chamber 124 and a first rebound chamber 125. The second main piston 143 element separates the second synchronizing hydraulic chamber 141 into a second compression chamber 144 and a second rebound chamber 145. Thus, when the first synchronizing piston 122 moves along the first axis A1, the first synchronizing piston element 123 also moves along the first axis A1. The movement of the first synchronizing piston element 123 along the first axis A1 changes the volumes of the first compression chamber 124 and the first rebound chamber 125. When the second synchronizing piston 142 moves along the second axis A2, the second synchronizing piston element 143 also moves along the second axis A2. The movement of the second synchronizing piston element 143 along the second axis A2 changes the volumes of the second compression chamber 144 and the second rebound chamber 145.

The first crossing cylinder 12 and the second crossing cylinder 14 are in the shown embodiment structured identically. However, the first crossing cylinder 12 and the second crossing cylinder 14 may differ structurally from each other.

The first compression chamber 124 is fluidly connected to the second rebound chamber 145 via a first synchronizing hydraulic line 17. The first rebound chamber 125 is fluidly connected to the second compression chamber 144 via a second synchronizing hydraulic line 18. The fluid connections between the compression chambers 124 and 144 and the rebound chambers 125 and 145 synchronize the movement of the first synchronizing piston 122 and the second synchronizing piston 142. The movements of the first synchronizing piston 122 and the second synchronizing piston 142 are synchronized by the fluid connections between the compression chambers 124 and 144 and the rebound chambers 125 and 145 keeping the volume ratio between the volume of the first rebound chamber 125 and the second compression chamber 144 and the volume of the second rebound chamber 145 and the first compression chamber 124 constant. This constant volume ratio assures that the first synchronizing piston 122 and the second synchronizing piston 142 moves in sync with each other. Thus, when the first compression chamber 124 is compressed, due to the first synchronizing piston 122 moving, fluid is transferred from the first compression chamber 124 to the second rebound chamber 145, thus expanding the second rebound chamber 145 and leading to a compression of the second compression chamber 144, which results in the second synchronizing piston 142 moving in sync with the first synchronizing piston 122. Consequently, the fluid connection between the compression chambers 124 and 144 and the rebound chambers 125 and 145 assures that the synchronizing pistons 122 and 142 move in sync with each other. In the shown embodiment, the first fluid connection 17 between the first compression chamber 124 and the second rebound chamber 145 form a first closed fluid circuit and the second fluid connection 18 between the first rebound chamber 125 and the second compression chamber 144 form a second closed fluid circuit.

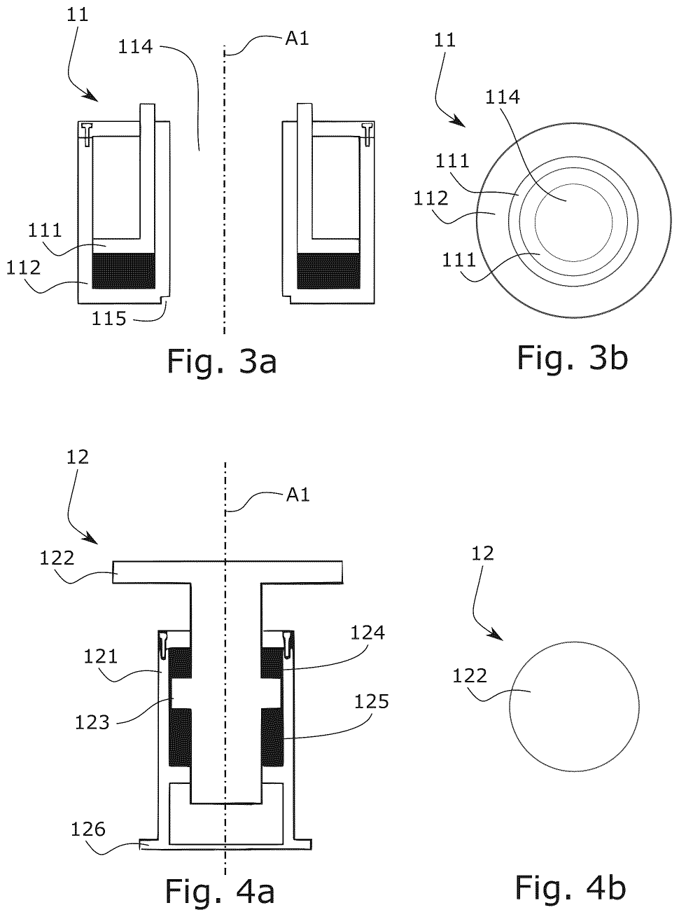

Referring to FIGS. 3a and 3b, where FIG. 3a depicts a schematic cross-sectional view of a first main cylinder 11 according to an embodiment of the invention, and FIG. 3b depicts a schematic top view of the first main cylinder 11 of FIG. 3a. The following described in relation to the first main 11 and a first crossing cylinder 12 is equally applicable to a second main cylinder 13 and a second crossing cylinder 14, respectively. The first main cylinder 11 is hollow and defines a first inner compartment 114. The first inner compartment 114 being configured to receive a first crossing cylinder 12. A cross-section of the first main cylinder 11 in a plane perpendicular to the first axis A1 is substantially formed as a hollow cylinder with the hydraulic chamber 112 defining the outer and inner diameter of the hollow cylinder with the first inner compartment 114 being placed in the center of the hollow cylinder. The first main hydraulic chamber 112 occupies 60-90% of a first cylinder area, where the first cylinder area is a cross-sectional area of the first hydraulic chamber 112 and the first inner compartment 114 in the plane perpendicular to the first axis A1. Furthermore, formed in the first main cylinder 11 is a circular groove 115. The circular groove 115 may facilitate a locking engagement between a first crossing cylinder 12 received in the first inner compartment 15 and the main cylinder 11. This locking engagement may be achieved by providing the first crossing cylinder 12 with one or more protrusions 126, which matches that of the locking groove 115, thus the one or more protrusions 126 of the first crossing cylinder 12 may engage the circular groove 115 of the first main cylinder 11. The locking engagement between the one or more protrusions 126 and the circular groove 115 may prevent movement of the first crossing cylinder 12 and the first main cylinder 11 relative to each other. The circular groove 115 is formed in the first hydraulic chamber 112. The first main piston 111 is formed with a cross-section which in a plane parallel to the first axis A1 is substantially L-shaped.

Referring to FIGS. 4a and 4b, where FIG. 4a depicts a schematic cross-sectional view of a first crossing cylinder 12 according to an embodiment of the invention, and FIG. 4b depicts a schematic top view of the first crossing cylinder 12 of FIG. 4a. The following described in relation to the first crossing cylinder 12 and a first main cylinder 11 is equally applicable to a second crossing cylinder 14 and a second main cylinder 13, respectively. The first crossing cylinder 12 comprises a first synchronizing hydraulic chamber 121 and a first synchronizing piston 122. The first synchronizing piston 122 further comprises a first synchronizing piston element 123. The first synchronizing piston element 123 is formed as a protrusion on the first synchronizing piston 122. Alternatively, the first synchronizing piston element 123 may be provided a seal or similar. The first synchronizing piston element 123 is configured to move together with the first synchronizing piston 122 along a first axis A1. The first synchronizing piston element 123 separates the first synchronizing hydraulic chamber 121 into a first compression chamber 124 and a first rebound chamber 125. When the first synchronizing piston element 123 moves together with the first synchronizing piston 122 along the first axis A1, the volume of the first compression chamber 124 and the first rebound chamber 125 changes accordingly. The first synchronizing piston 122 is substantially circular when seen from the bearing housing, as shown on FIG. 4b. The first synchronizing hydraulic chamber 121 has a substantially circular cross-section in a plane perpendicular to the first axis A1. The first synchronizing hydraulic chamber 121 is provided with a protrusion 126. The protrusion 126 is formed as a circular flange extending around a circumference of the first synchronizing hydraulic chamber 121. The protrusion 126 is configured to act as a male connector which may engage a corresponding female connector on the first main cylinder 12.

Although some embodiments have been described and shown in detail, the invention is not restricted to them, but may also be embodied in other ways within the scope of the subject matter defined in the following claims. In particular, it is to be understood that other embodiments may be utilized and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A hydraulic system for a roller crusher comprising a machine frame, a fixed roll supported by one or more fixed bearing housings fixed relative to the machine frame, a movable roll supported by first and second movable bearing housings movable relative to the machine frame, and wherein the fixed roll and the movable roll defines a crushing gap for receiving material to be comminuted, the hydraulic system comprising:
a first main cylinder connectable to the first movable bearing housing and comprising a first main piston for exerting a force along a first axis resulting in a force on the first movable bearing housing, and a first main hydraulic chamber for controlling the force exerted by the first main piston,
a second main cylinder connectable to the second movable bearing housing and comprising a second main piston for exerting a force along a second axis parallel to the first axis resulting in a force on the second movable bearing housing, and a second main hydraulic chamber for controlling the force exerted by the second main piston,
a first crossing cylinder connectable to the first movable bearing housing and operationally coupled to the first main piston, comprising a first synchronizing hydraulic chamber and a first synchronizing piston for exerting a force along the first axis resulting in a force on the first movable bearing housing, wherein the first synchronizing piston extends into the first synchronizing hydraulic chamber and comprises a first synchronizing piston element separating the first synchronizing hydraulic chamber into a first compression chamber and a first rebound chamber,
a second crossing cylinder connectable to the second movable bearing housing and operationally coupled to the second main piston comprising a second synchronizing hydraulic chamber and a second synchronizing piston for exerting a force along the second axis resulting in a force on the second movable bearing housing, wherein the second synchronizing piston extends into the second synchronizing hydraulic chamber and comprises a second synchronizing piston element separating the second synchronizing hydraulic chamber into a second compression chamber and a second rebound chamber, and
wherein the first compression chamber is fluidly connected to the second rebound chamber and the first rebound chamber is fluidly connected to the second compression chamber.

2. The hydraulic system according to claim 1, wherein the first main hydraulic chamber is hollow and defines a first inner compartment, wherein the second main hydraulic chamber is hollow and defines a second inner compartment, and wherein the first crossing cylinder is arranged in the first inner compartment and the second crossing cylinder is arranged in the second inner compartment.

3. The hydraulic system according to claim 2, wherein the first main hydraulic chamber occupies 60-90% of a first cylinder area and the second main hydraulic chamber occupies 60-90% of a second cylinder area, wherein the first cylinder area is a cross-sectional area of the first hydraulic chamber and the first inner compartment and the second cylinder area is a cross-sectional area of the second hydraulic chamber and the second inner compartment.

4. The hydraulic system according to claim 1, wherein the fluid connection between the first compression chamber and the second rebound chamber form a first closed fluid circuit and the fluid connection between the first rebound chamber and the second compression chamber form a second closed fluid circuit.

5. A The hydraulic system according to claim 1, further comprising one or more hydraulic accumulators in fluid connection with the first main hydraulic chamber and/or the second main hydraulic chamber.

6. The hydraulic system according to claim 1, wherein the first synchronizing piston and the first synchronizing piston element are integrally connected, and the second synchronizing piston and the second synchronizing piston element are integrally connected.

7. The hydraulic system according to claim 1, wherein the first crossing cylinder is engaged with the first main cylinder to prevent movement of the first crossing cylinder relative to the first main cylinder in a first plane perpendicular to the first axis, and/or the second crossing cylinder is engaged with the second main cylinder to prevent movement of the second crossing cylinder relative to the second main cylinder in in a second plane perpendicular to the second axis.

8. The hydraulic system according to claim 1, wherein the first main piston is connected with the first synchronizing piston and/or the second main piston is connected with the second synchronizing piston.

9. The hydraulic system according to claim 8, wherein the first main piston is integrally connected with the first synchronizing piston and/or the second main piston is integrally connected with the second synchronizing piston.

10. The hydraulic system according to claim 1, wherein the first main piston is configured to deliver the force along the first axis onto the first synchronizing piston and/or the second main piston is configured to deliver the force along the second axis onto the second synchronizing piston.

11. A roller crusher for comminution of material comprising:
a machine frame,
a fixed roll supported by fixed bearing housings, wherein the fixed bearing housings are fixed relative to the machine frame,
a movable roll supported by movable bearing housings, wherein the movable bearing housings are movable relative to the machine frame, wherein the fixed roll and the movable roll defines a crushing gap for receiving material to be comminuted, and
a hydraulic system according to claim 1, wherein the hydraulic system is configured to deliver a force onto the movable bearing housing to bias the movable roll towards the fixed roll.
